(19) United States
(12) Patent Application Publication
(10) Pub. No.: US 2011/0124230 A1
(43) Pub. Date: May 26, 2011

(54) ELECTRICAL CONNECTOR WITH ALIGNMENT BOARD SLOT

(75) Inventor: YU ZHU, shenzhen (CN)

(73) Assignee: HON HAI PRECISION INDUSTRY CO., LTD., Tu-Cheng (TW)

(21) Appl. No.: 12/886,103

(22) Filed: Sep. 20, 2010

(30) Foreign Application Priority Data
Nov. 24, 2009 (CN) 200920315539.0

(51) Int. Cl. H01R 24/00

(52) U.S. Cl. 439/630; 439/660

(57) ABSTRACT

An electrical connector includes an insulative housing and a plurality of terminals received in the housing. The insulative housing includes a longitudinal uninterrupted mating cavity extending in a first direction and through a front face thereof in a second direction perpendicular to the first direction. A plurality of terminals is retained at a first wall of the insulating housing and comprising contacting portions exposing in the mating cavity. The uninterrupted mating cavity comprises a horizontal main slot extending in the first direction, a first auxiliary slot located at the first wall and a pair of second auxiliary slot at two opposite ends of the horizontal main slot in the first direction.

### BACKGROUND OF THE INVENTION

1. Field of the Invention

The present invention relates to an electrical connector which is adapted for two different counter equipments, such as a counter connector and a printed circuit board.

2. Description of Related Art

A popular standard of electrical connector which is widely used in the storage device is called “Serial Advanced Technology Attachment (Serial ATA)”. U.S. Pat. No. 6,773,293 issued on Aug. 10, 2004 to George Lee discloses a connector assembly generally named as Serial ATA Connector including a cable connector and a board connector. The cable connector has a longitudinal L-shaped mating slot with a plurality of first terminals protruding therein. The board connector has an L-shaped tongue portion with a plurality of terminals inserted therein for mating with the slot of the cable connector.

Sometimes, a board electrical connector adapted for being inserted by different types of counter equipment is needed in the miniaturization and diversified tendency of electronic device. The counter equipment is of cable electrical connector generally, for example, the cable connector in U.S. Pat. No. 6,773,293. A printed circuit board etched with golden fingers taken place of the cable connector is hoped to also be inserted in the electrical connector in consideration of diversified tendency. However, dimensions of the mating portions in the slot of the cable connector and the printed circuit board are different, a co-port electrical connector is desired.

### BRIEF SUMMARY OF THE INVENTION

The present invention provides an electrical connector including an insulative housing and a plurality of terminals received in the housing. The insulative housing includes a longitudinal uninterrupted mating cavity extending in a first direction and through a front face thereof in a second direction perpendicular to the first direction. A plurality of terminals is retained at a first wall of the insulating housing and comprising contacting portions exposing in the mating cavity. The uninterrupted mating cavity comprises a horizontal main slot extending in the first direction, a first auxiliary slot located at the first wall and a pair of second auxiliary slot at two opposite ends of the horizontal main slot in the first direction.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of the electrical connector disconnecting with a circuit board;

FIG. 2 is a front view of the electrical connector;

FIG. 3 is a front schematic view of the electrical connector with the circuit board received in; and

FIG. 4 is a front view of an electrical connector of another embodiment.

### DETAILED DESCRIPTION OF THE PREFERRED EMBODIMENTS

Reference will now be made to the drawing figures to describe the preferred embodiment of the present invention in detail.

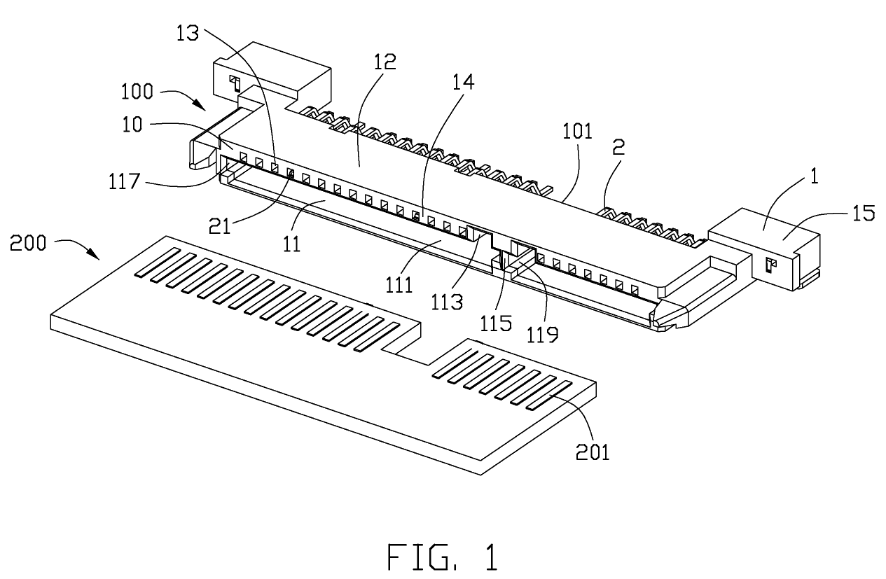

Referring to FIG. 1 an electrical connector 100 for mating with a standard Serial ATA board connector (not shown) and a printed circuit board 200 is shown, which includes an insulative housing 1 defining a forwardly protruding mating portion 12 with a front face 10 and an opposite back face 101. The mating portion 12 has two substantially L shaped mating cavities 11 side-by side divided by a partition 115. The two mating cavities extending lengthwise have similar shape except the length and orientation of letter L, so one mating cavity is described hereinafter. Each mating cavity 11 is defined running though the front face 10. A plurality of spaced passageways 13 configured to extend from the front face 10 to the back face 101 are disposed along a first lengthwise wall 14 of the mating cavity 11 to communicate with the mating cavity 11. A plurality of terminals 2 are inserted in the passageways 13 in a front-and back direction from the back face 101 to the front face 10 of the mating portion 12 with front tip 21 pro-loading on the first wall near the front face. Please note, the passageways 13 in left mating cavity in the drawing sheet receive power terminals and passageways 13 in the right mating cavity receive signal terminals.

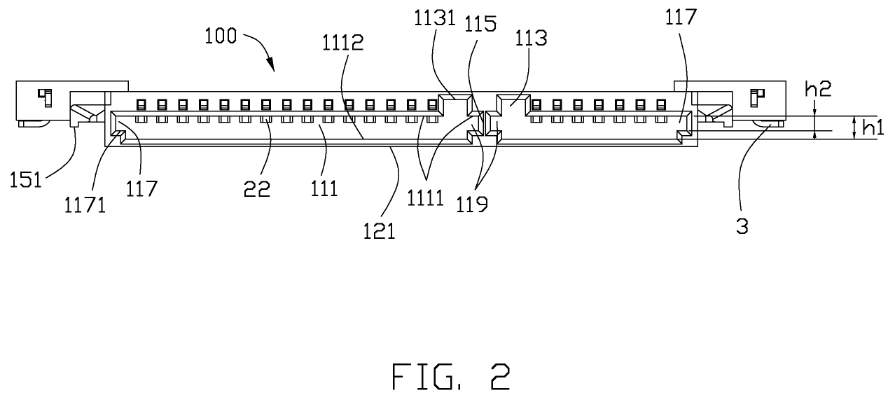

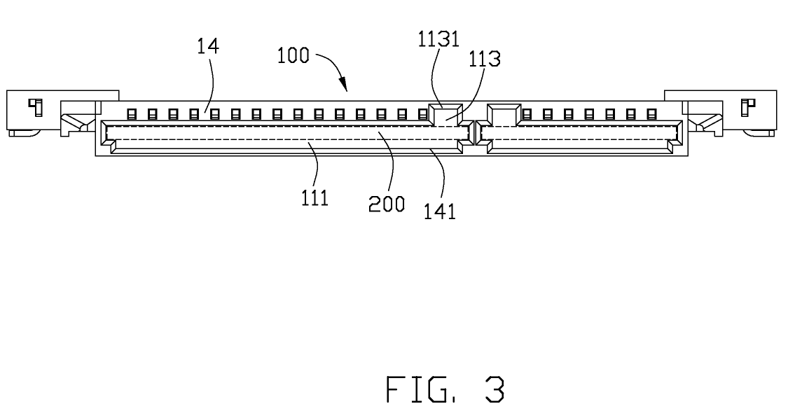

Combination with FIGS. 1 and 2, each of the two mating cavity 11 is uninterrupted and includes a horizontal main slot 111 and a vertical first auxiliary slot 113 disposed at one end of the horizontal main slot 111 and closed to the partition 115. The mating cavity 11 further includes a pair of second auxiliary slots 117, 119 at two ends of the main slot 111. The pair of the second auxiliary slot horizontally extends from two ends of the main slot 111 and communicates with the main slot 111, one second auxiliary slot 119 is adjacent to the first auxiliary slot 113 and the other is far away the first auxiliary slot 113. Please note and refer to FIG. 2, the contacting portions 22 of the contacts expose only in the main sot 111 while the first auxiliary slot 113 and the second auxiliary slots 117,119 has no contacting portions therein. The second auxiliary slots 117,119 and the main slot has a co-plane top inside face 1111 while the bottom face 1112 of the main slot is lower than the bottom inside faces 1171 of the second auxiliary slot 117,119. The top inside face 1131 of the first auxiliary slot is higher than the top inside face 1111. Thus the main slots 111 with a standard width h1 and the first auxiliary slots 113 together are shaped compatibly for a standard Serial ATA connector while the main slots 111 and the pairs of second auxiliary slots 117, 119 with width h2 together are shaped for the circuit board 200. The width h1 is smaller than the width h2 since the circuit board 200 is thinner so as to hold the circuit board 200 in mating cavities as shown in FIG. 3. The circuit board 200 spaces from a second wall 141 opposite to the first wall 14, and supports and limits by the second auxiliary slots 117, 119 in the lengthwise direction and height direction. The first auxiliary slot 113 is used for supporting and anti-mismating of a counter connector.

Referring particularly to FIGS. 1 and 2, the insulative housing 10 further includes a pair of mounting ears 15 located at opposite ends of a back portion of the insulative housing 1, the mounting ears 15 defining a board mounting face 151 adapted to be mounted onto a mounting board (not shown). The mating portion 12 also includes a bottom face 121 extending between the front face 10 and the back face 101 and locatable below the board mounting face 151 of the mounting ears 15. In addition, a pair of soldering pad 3 is positioned at opposite sides of the mounting ears 15, with each having a soldering plane being coplanar with the board mounting face 151.

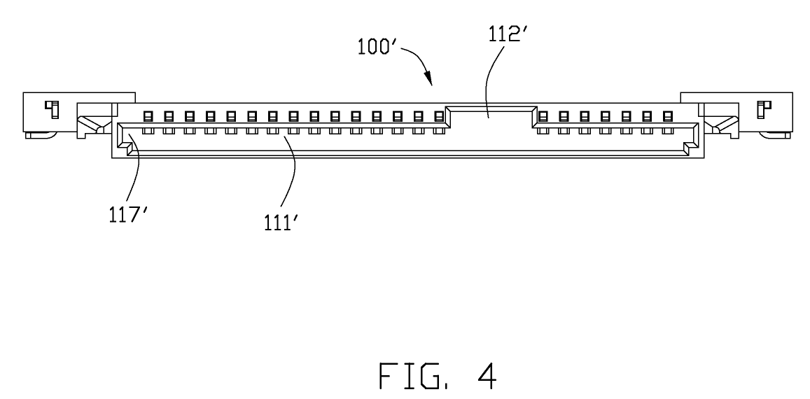

Referring to FIG. 4, another embodiment of this invention is known as a Serial Attached SCSI (SAS) standard which has similar structure with Serial ATA. Hereafter, difference between them will be mainly introduced. The connector 100′ further forms a uninterrupted longitudinal mating cavity which includes a horizontal main slot 111′, a first auxiliary slot 112′ and a pair of second auxiliary slot 117′. The first auxiliary slot 112′ is located near a middle portion of the main slot. The first auxiliary slot 112′ divides the passageways into two groups, the left one is for receiving power terminals and the other is for receiving power terminals. Without forming the partition, only two second auxiliary slots 117′ are extended along both longitudinal ends of the main slots 111′ for engaging the both board edges of the circuit board (not shown).

It is to be understood, however, that even though numerous, characteristics and advantages of the present invention have been set forth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. An electrical connector, comprising:
an insulative housing defining a longitudinal uninterrupted mating cavity extending in a first direction and through a front face thereof in a second direction perpendicular to the first direction;
a plurality of terminals retained at a first wall of the insulating housing and comprising contacting portions exposing in the mating cavity;
the uninterrupted mating cavity comprising a main slot extending in the first direction, a first auxiliary slot located at the first wall and a pair of second auxiliary slot at two opposite ends of the main slot along the first direction.

2. The electrical connector as claimed in claim 1, wherein the main slot and the pair of the second auxiliary slots has a co-plane top inside face at the first wall and a bottom inside face opposite to the top inside face of the main slot is lower than that of the pair of second auxiliary slots.

3. The electrical connector as claimed in claim 2, wherein the first auxiliary slot has a top inside wall is high than then the top inside wall of the main slot.

4. The electrical connector as claimed in claim 3, wherein the electrical connector has two said uninterrupted mating cavities spaced by a partition, each first auxiliary slot of the cavities is close to the partition.

5. The electrical connector as claimed in claim 1, wherein the main slots and the first auxiliary slots together are shaped compatibly for a standard Serial ATA connector while the main slots and the pairs of second auxiliary slots together are shaped for a circuit board inserted in the mating cavity.

6. The electrical connector as claimed in claim 1, wherein the main slots and the first auxiliary slots together are shaped compatibly for a standard Serial Attached SCSI (SAS) connector intending to be inserted in the mating cavity while the main slots and the pairs of second auxiliary slots together are shaped for a circuit board intending to be inserted in the mating cavity.

7. The electrical connector as claimed in claim 1, wherein the insulative housing defines a board mounting face, the mating portion has a bottom face between the front face and the back face, the bottom face of the mating portion is disposed below the board mounting face.

8. An electrical connector, comprising:
an insulative housing defining a rectangular receiving cavity composed by opposite end walls and adjoining opposite side walls;
a plurality of terminals retained in one of the side walls and comprising contacting portions exposing in the receiving cavity;
board receiving slots with smaller width than that of the end walls are extended along both longitudinal ends of the cavity for holding a circuit board and making connect with the terminals.

9. The electrical connector as claimed in claim 8, wherein the board receiving slots and the side wall which holds terminals have a co-plane inside face.

10. An electrical connector for mating with a board like module defining a thickness thereof, comprising:
an elongated housing defining two opposite lengthwise side walls extending along a lengthwise direction, and two opposite end walls located at and linking two opposite ends of said lengthwise side walls in a lateral direction perpendicular to said lengthwise direction;
at least one mating cavity uninterruptedly defined in said elongated housing, said mating cavity including a main slot extending along said lengthwise direction with essentially a first width, which is defined in said lateral direction, significantly larger than said thickness except at two spaced first and second positions where the housing defines two spaced protrusions invading the main slot to form a second width, which is defined said lateral direction, only slightly larger than said thickness so as to have the board like module to be snugly held in the main slot without improper vibration; wherein
one of said two opposite lengthwise side walls is equipped with terminals for mating with the board like module, and said two spaced protrusions are formed on the other of said two opposite lengthwise side walls.

11. The electrical connector as claimed in claim 10, wherein all terminals are disposed in said one of the two opposite lengthwise side walls.

12. The electrical connector as claimed in claim 10, wherein said first and second positions are located at two opposite ends of the main slot.

13. The electrical connector as claimed in claim 10, wherein said housing further includes another mating cavity have a similar structure with said mating cavity while spaced from the mating cavity via a partition wall along said lengthwise direction.

14. The electrical connector as claimed in claim 13, wherein said first and second positions are located at two opposite ends of the main slot so as to have one of said two spaced protrusions, which invades the main slot, located by one side of the partition wall.

15. The electrical connector as claimed in claim 13, wherein one of the two spaced protrusions, which invades the corresponding main slot of another mating cavity, is located by the other side of the partition wall.

16. The electrical connector as claimed in claim 10, wherein said one of the two opposite lengthwise side walls further defines a recess around one end of the main slot for performing a key function.

17. The electrical connector as claimed in claim 16, wherein said housing further includes another mating cavity have a similar structure with said mating cavity while spaced from the mating cavity via a partition wall along said lengthwise direction, under condition that the recess of said mating cavity is located adjacent to one side of said partition wall and the recess of another mating cavity is adjacent to the other side of said partition wall.

18. The electrical connector as claimed in claim 17, wherein said first and second positions are located at two opposite ends of the main slot so as to have one of said two spaced protrusions, which invades the main slot, located by one side of the partition wall.

19. The electrical connector as claimed in claim 18, wherein one of the two spaced protrusions, which invades the corresponding main slot of another mating cavity, is located by the other side of the partition wall.

20. The electrical connector as claimed in claim 16, wherein said recess is aligned with neither one of said first and second spaced protrusion in said lateral direction.
